(19) United States
(12) Patent Application Publication
(10) Pub. No.: US 2016/0245014 A1
(43) Pub. Date: Aug. 25, 2016

(54) Window Reinforcing Assembly

(71) Applicant: Thomas Rafter, Wichita, KS (US)

(72) Inventor: Thomas Rafter, Wichita, KS (US)

(21) Appl. No.: 15/147,596

(22) Filed: May 5, 2016

Related U.S. Application Data
(63) Continuation of application No. 14/520,981, filed on Oct. 22, 2014.
(60) Provisional application No. 61/895,918, filed on Oct. 25, 2013.

(51) Int. Cl. E06B 5/11; F41H 5/26; E06B 3/96; F41H 5/04; E06B 5/10; E06B 5/12

(52) U.S. Cl. CPC E06B 5/113; E06B 5/106; E06B 5/12; E06B 5/103; E06B 3/96; F41H 5/0407; F41H 5/26

(57) ABSTRACT

A break-in resistant window assembly whose components include a pane having at least a pair of edges and a corner; a frame boarding the pane; a sheet of polymeric film overlying the pane, a first adhesive layer fixedly interconnecting the pane and the sheet of polymeric film; a corner piece having a pair of legs; a pair of trim engaging lugs fixedly attached to the legs' distal ends; a first adhesive pads attaching the corner piece to the frame and attaching the corner piece to the sheet of polymeric film; a pair of trim pieces having proximal end openings receiving the trim engaging lugs; and a plurality of second adhesive pads attaching the trim pieces to the frame and to the sheet of polymeric film.

### CROSS REFERENCES TO RELATED APPLICATIONS

This application is a continuation of U.S. non-provisional patent application Ser. No. 14/520,981 filed on Oct. 22, 2014, which is incorporated herein by reference.

U.S. non-provisional patent application Ser. No. 14/520,981 claimed the benefit of U.S. provisional application Ser. No. 61/895,918 filed on Oct. 25, 2013 which is incorporated herein by reference.

### FIELD OF THE INVENTION

This invention relates to apparatus, articles, and assemblies which are adapted for protecting glass windows from breakage. More particularly, this invention relates to such assemblies which incorporate a polymeric or plastic transparent film applique as a reinforcing component.

### BACKGROUND OF THE INVENTION

Transparent polymeric or plastic films are known to be adhesively applied to the surfaces of transparent glass windows for purposes including window tinting, UV light filtering, maintenance of window screen integrity, and protection against inward projections of glass fragments and shards upon window breakage. Where additional protective measures are sought, transparent window films having thicknesses up to 400 micrometers or 1/62″ are known to be adhesively applied to glass window surfaces, such thicker film appliques maintaining the integrity of the window glass as a barrier in events such as bomb blasts or impacts with storm driven debris.

Such thicker window film appliques are known to provide some protection against purposeful breakage by a burglar. However, such appliques by themselves are only marginally effective because burglars may consciously and purposefully direct strikes against the glass at and about its edges, breaking the window along its juncture with the window's frame. Such directed breakage by a burglar tends to inwardly separate both the glass window and its reinforcing film applique from the window frame, allowing the burglar's entry.

In order to enhance such thickened window film appliques' capacity for resisting impacts and breakage, trim strips are known to be provided and adhesively applied about the periphery of a film reinforced window. Such trim strips provide a structural reinforcing bridge or tie between the film which reinforces the window and the window's peripheral frame. Such additional window reinforcing trim strips are effective in maintaining a glass window's ability to remain in place and to continue to function as a screen or barrier upon experiencing a bomb blast or storm debris impacts. However, installations of such adhesively applied peripheral trim continue to be only marginally effective against purposeful efforts by burglars to gain access to buildings via window breakage. Such adhesively applied trim pieces typically include weak points at mitered corners, and burglars upon seeing such reinforcing trim, may concentrate blows at the window's corners. The typically mitered corners of such adhesively applied reinforcing trim tend to interrupt the structural continuity of the reinforcing trim about the periphery of the film reinforced window. Such mitered corners also undesirably invite a burglar's impacts at the window's corners and allow such impacts to successfully inwardly deflect the reinforced window.

The instant inventive window reinforcing assembly solves or ameliorates the problems, defects, and deficiencies described above, by incorporating within a polymeric film window reinforcement system, a specialized corner piece which markedly lessens corner zone structural weaknesses, and which effectively frustrates a burglar's efforts to break the reinforced window at the window's corner.

### SUMMARY OF THE INVENTION

A first structural component of the instant inventive window reinforcing assembly comprises at least a first, and preferably a plurality of corner pieces, each corner piece preferably being substantially “L” shaped, and having a pair of window frame contacting legs. In a preferred embodiment, each of the corner pieces' legs has a distal end, a window contacting face, and a frame contacting face. Also in the preferred embodiment, specially fitted trim engaging pins or lugs are fixedly attached to and extend distally from the legs' distal ends.

Further preferred structural components of the instant inventive assembly comprise adhesive pads attached to the corner pieces' window contacting and frame contacting faces.

Further structural components of the instant inventive assembly comprise at least a first, and preferably a pair of stop pin receiving sockets, such sockets preferably opening at the legs' flat window frame contacting faces.

In use of the instant inventive assembly and assuming that a window having a peripheral frame has been preliminarily reinforced by adhesively applied polymer coating or film, one of the corner pieces among the instant invention's plurality of corner pieces may be adhesively installed at each of the window's corners. In such installations, the adhesive pads located at the window contacting faces of the corner pieces' legs preferably directly contact and overlap the edges of the window's reinforcing film.

Where the corner pieces include stop pin reinforcing sockets, as is preferred, stop pins may be advantageously preliminarily installed at the window frame's corners. Such pins may comprise screw or bolt heads which are received within and engage the corner pieces' stop pin receiving sockets. Upon installation and engagements of such stop pins, a burglar's inwardly directed impacts at the corner of the reinforced window are resisted by structural ties which advantageously span between the window and its reinforcing trim and such stop pins. Such ties advantageously prevent inward deflections of the window at its corners.

In installation of the preferred embodiment of the assembly as described above, the fitted lugs or reinforcing pins which extend from the distal ends of the corner pieces' legs preferably nestingly extend into, and are adhesively bound within matching sockets or channels which open at the ends of conventional straight trim pieces, such straight pieces being installed about the periphery of the window.

Upon installation of the instant invention's reinforcing assembly in the manner described above, the corner piece components constitute, in the view of a burglar attempting to break the window, a structural equivalent of a prior art reinforced window which is inherently relatively weak at the corners. Such burglar may thereby be led to direct breaking impacts against the corners of the window pane. However, under the operation of the instant invention, such typically weak corner zones have been desirably transformed into zones of substantially increased strength and integrity. Accordingly, the instant inventive assembly operates to markedly increase the reinforced window's ability to resist break in efforts by burglars.

Accordingly, objects of the instant invention include the provision of a window reinforcing assembly which incorporates structures, as described above, and which arranges those structures in relation to each other, in manners described above, for the achievement of the objects, benefits, and advantages as described above.

Other and further objects, benefits, and advantages of the present invention will become known to those skilled in the art upon review of the Detailed Description which follows, and upon review of the appended drawings.

### BRIEF DESCRIPTION OF THE DRAWINGS

FIG. 1 is a view of a corner piece component of the instant inventive assembly.

FIG. 2 is a reverse perspective view of the structure depicted in FIG. 1.

FIG. 3 is a perspective view of a length of prior art window reinforcing trim.

FIG. 4 shows the instant inventive assembly installed upon a polymeric film reinforced window.

### DETAILED DESCRIPTION OF A PREFERRED EMBODIMENT

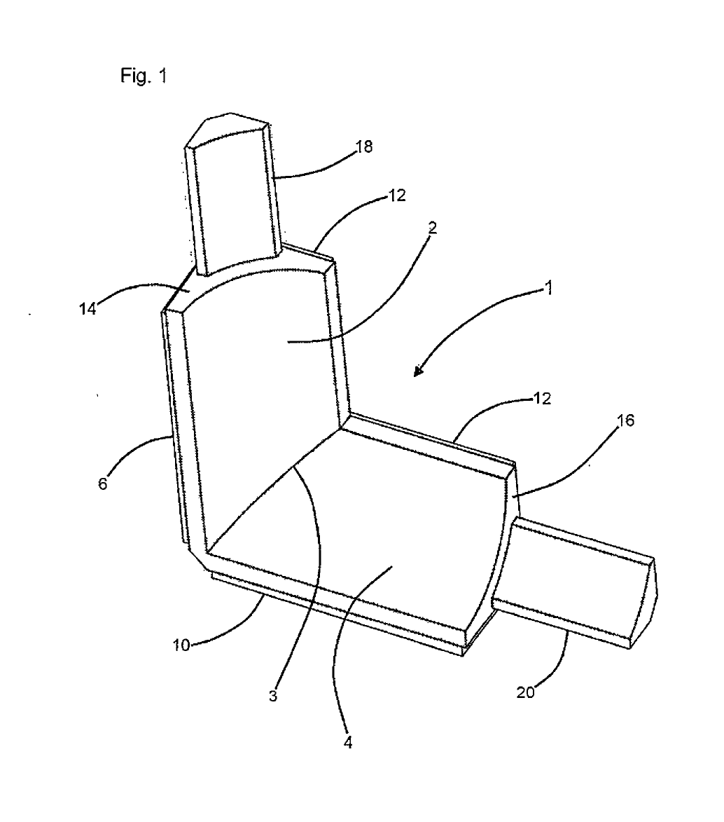

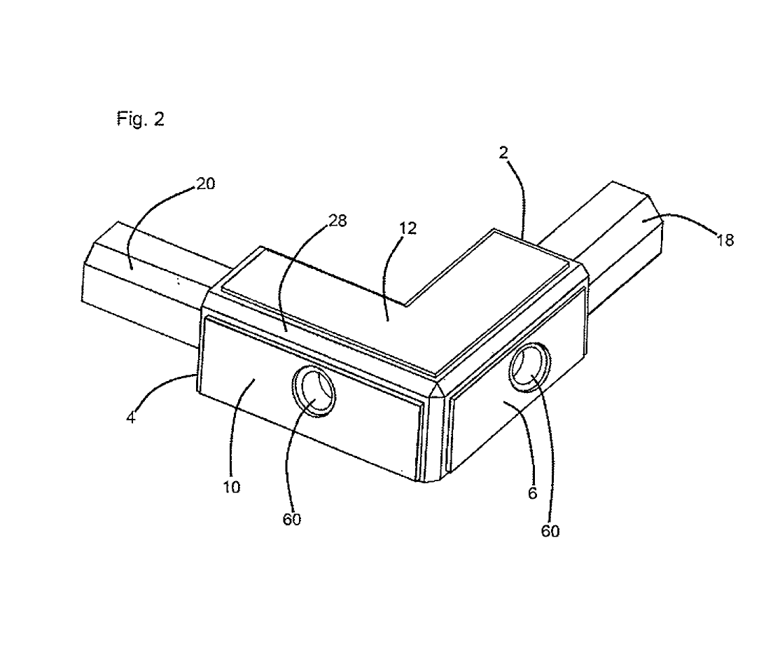

Referring now to the drawings, and in particular to Drawing FIGS. 1 and 2, a preferred embodiment of a corner piece component of the instant inventive assembly is referred to generally by Reference Arrow 1. The corner piece 1 preferably comprises a pair of distally extending legs 2 and 4 which are oriented at a 90 degree. angle with respect to each other, and which include a faux mitered seam or juncture 3 therebetween at their proximal ends. An “L” shaped pressure actuated adhesive pad 12 or at least first adhesive pad is preferably adhesively attached to flat window contacting sides of the legs 2 and 4.

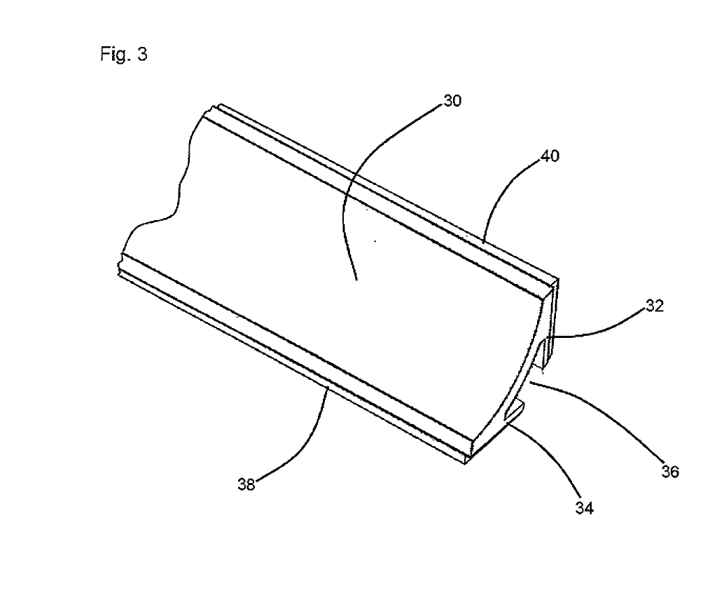

Referring simultaneously to FIGS. 1-3, lengths of prior art trim pieces 30 structurally correspond with the legs 2 or 4 of corner piece 1, such prior art trim pieces 30 having flat window frame contacting sides 32 and 34, and having adhesive pads 40 and 38, such pads constituting a plurality of second adhesive pads. The prior art trim pieces 30 conventionally form a hollow interior “C” channel which open at their proximal ends. Lugs or pins 18 and 20 which respectively distally extend from the distal ends 14 and 16 of the corner piece's legs 2 and 4 are preferably closely fitted for insertions into, and nesting receipts within such trim piece “C” channels 36. In a preferred embodiment, stop pin receiving sockets 60 open at third adhesive pads 6 and 10 and at the corner piece's window frame contacting faces.

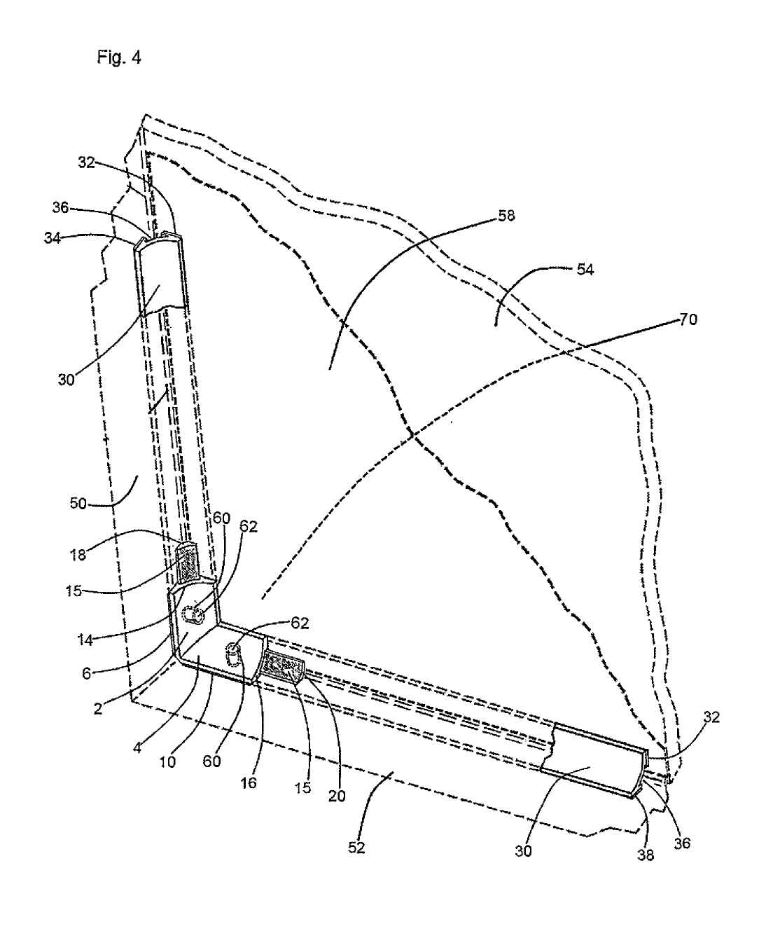

In use of the instant inventive reinforcing assembly and referring in particular to FIG. 4, a glass window pane 54 mounted within a window frame 50, 52 may be preliminarily reinforced by a durable and transparent sheet of polymeric film 58, such polymeric film being adhesively applied by a first adhesive layer to the interior surface of window 54. Following installation of film 58, a pair of stop pins 62 may be preliminarily installed at each of the corners of the window frame 50, 52, such pins 62 preferably being placed, referring further simultaneously to FIGS. 1-3, so that upon installation of a corner piece 1 as indicated in FIG. 4, sockets 60 nestingly receive and may engage pins 62. Upon configuration of the inventive assembly as indicated in FIG. 4, adhesive pad 12 securely attaches the corner piece 1 to film 58 and to window 54 while adhesive pads 6 and 10 correspondingly securely attach the corner piece 1 to the window frame 50, 52.

In the preferred embodiment of the instant inventive assembly, and assuming that window film 58 and stop pins 62 have been preliminarily installed as indicated and depicted, a solvent based rubber cement 15 may be preliminarily disposed over the surfaces of pins 18 and 20, such dispositions 18 and 20 constituting second adhesive layers. Thereafter, straight lengths of reinforcing trim 30 may be installed along frame members 50 and 52. In such installations, the rubber cement 15 disposed over pins 18 and 20 initially functions as a lubricant which eases sliding installations of the straight lengths “C” channels 36 over the pins 18 and 20. Upon hardening of the rubber cement 15, the window reinforcing effect of straight lengths 30 advantageously continues at the corners of the window frame 50, 52 while the engagements of pins 62 within sockets 60 enhance the reinforcing strength of the system at the corners beyond the reinforcing strength provided by straight lengths 30. Such other corners of the window and frame components of the assembly constitute a plurality of second corners, and corner pieces similar to corner piece 1 which reinforce those second corners constitute a plurality of second corner pieces. Suitably, screws extending entirely through the corner pieces 1 may be provided in place of the inwardly hidden socket and pin combinations 62 and 60. However, use of such exposed corner piece mounting screws is less desirable because they may be viewed from the outside by a burglar who may undesirably detect and understand the corner reinforced nature of the reinforced window.

In operation of the instant inventive assembly, and referring simultaneously to all figures, a burglar located at the outside of window 54 may seek to gain ingress via breakage of such window. Such burglar, upon seeing trim pieces 30 extending about the periphery of the window 54, and upon seeing the faux mitered seam 3 of corner piece 1 may thereby be attracted or led to direct impacts against the window 54 at and about corner zone 70, such burglar erroneously believing that zone 70 constitutes a weak point in the window's reinforcing system. Breakage efforts directed against corner zone 70 of window 54 are desirably frustrated by the mechanically inter-linked adhesive pads 6, 10, and 12, pins 62, sockets 60, pins 18 and 20, and adhesive 15.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope commensurate with the appended claims.

Having thus described the invention, what is claimed as new and desired to be secured by Letters Patent is:

1. A break-in resistant window assembly comprising:
(a) a pane having at least a pair of edges and a corner, the at least pair of edges meeting at the corner;
(b) a frame boarding the pane;
(c) a sheet of polymeric film overlying the pane, said sheet having at least a pair of edges and a corner, said sheet's at least pair of edges meeting at said sheet's corner;
(d) a first adhesive layer fixedly interconnecting the pane and the sheet of polymeric film;
(e) a corner piece having a flat window contacting side and having a flat frame contacting side, the flat window contacting and flat frame contacting sides meeting at a corner, the corner piece further comprising a pair of legs, each leg among the pair of legs having a distal end;
(f) a pair of trim engaging lugs, each lug among the pair of trim engaging lugs being fixedly attached to or formed wholly with one of the legs' distal ends;
(g) a first adhesive pad attaching the corner piece to the polymeric film sheet at said sheet's corner, the corner piece being further attached to the frame;
a pair of trim pieces having proximal ends, each trim piece having a channel opening at said each trim piece's proximal end, each channel nestingly receiving one of the trim engaging lugs; and
(i) a plurality of second adhesive pads attaching the trim pieces to the frame, the plurality of second adhesive pads further attaching the trim pieces to the sheet of polymeric film.

2. The break-in resistant window assembly of claim 1 further comprising a third adhesive pad, the corner piece's further attachment to the frame being effected by the third adhesive pad.

3. The break-in resistant window assembly of claim 2 further comprising a pair of second adhesive layers, each layer among the pair of second adhesive layers being disposed between one of the trim engaging lugs and one of the trim pieces' channels.

4. The break-in resistant window assembly of claim 3 wherein the corner piece comprises injection molded plastic.

5. The break-in resistant window assembly of claim 4 wherein the corner piece's legs have proximal ends, and further comprising a faux mitered joint positioned at said proximal ends.

6. The break-in resistant window assembly of claim 3 wherein the etwner-pfeee-antl-the trim pieces have flat window contacting sides and have flat frame contacting sides, each adhesive pad among the first, the plurality of second, and the third adhesive pads being disposed over one of said the sides among the corner piece's and trim pieces' flat window contacting and flat frame contacting sides.

7. The break-in resistant window assembly of claim 6 wherein the trim engaging lugs and the trim pieces' channels have triangular lateral cross-sectional shapes.

8. The break-in resistant window assembly of claim 7 wherein the corner of the sheet of polymeric film and the frame are mechanically linked by the corner piece and by the first and third adhesive pads.

9. The break-in resistant window assembly of claim 8 wherein the pane and the sheet of polymeric film have pluralities of second corners, and further comprising a plurality of second corner pieces, the frame being further mechanically linked with the sheet of polymeric film by the plurality of second corner pieces.
